(19) United States
(12) Patent Application Publication
(10) Pub. No.: US 2008/0313349 A1
(43) Pub. Date: Dec. 18, 2008

(54) CONNECTING A CLIENT TO ONE OF A PLURALITY OF SERVERS

(75) Inventors: Philip Richard Nickoll, Chandler's Ford (GB); Matthew Roberts, Chandler's Ford (GB); Graham Derek Wallis, West Wellow (GB); David Ware, Downton (GB)

Correspondence Address: IBM CORPORATION, 3039 CORNWALLIS RD., DEPT. T81 / B503, PO BOX 12195, RESEARCH TRIANGLE PARK, NC, 27709, US

(73) Assignee: International Business Machines Corporation, Armonk, NY (US)

(21) Appl. No.: 12/128,485

(22) Filed: May 28, 2008

(30) Foreign Application Priority Data
Jun. 12, 2007 (EP) 07110093.7

(51) Int. Cl. G06F 15/173

(52) U.S. Cl. 709/239

(57) ABSTRACT

In a client/server network, a client may be able to use any of several servers in accomplishing a particular task but may still have preferences as to which server should, if available, be used. If the preferred server is not available, the client will be connected to an alternate server. If a server having a higher preference than the alternate server becomes available, state information associated with the client session with the alternate server is used in order to decide when the client may be switched to the preferred server without compromising work currently being done.

### BACKGROUND OF THE INVENTION

The invention relates to connecting a client to a server in an environment in which multiple servers are available to the client.

In a client/server environment, multiple servers may be available to a single client. There may be a number of reasons why a client may prefer some servers over other servers. Some potential reasons are proximity of resources relative to the server, proximity of the client relative to the server, and user-specific preferences.

Such information is used at initial connect time to determine the best endpoint for a connection. Once an endpoint has been chosen, it will typically be used until the application has no further use for the connection or an error occurs on the connection.

There are systems that can implement a preference for one network over another and that proactively drop connections in order to choose between different networks available to the client. Such systems are limited to switching between heterogeneous networks.

It is also known for a client to switch endpoints when an endpoint to which a client is connected, fails or is stopped.

There are also file transfer, download and client technologies that provide transparent failover on loss of a connection. The switch to another endpoint is driven by the loss of a connection. Any state information maintained is at a simplistic level such as how much of a file has been downloaded thus far. Such state is held by the client.

### BRIEF SUMMARY OF THE INVENTION

The present invention may be implemented as a method for controlling client/server connections in a system in which a plurality of servers perform functions required by a client. When a client request for a server connection is received, any server preferences of the client are determined. The client is connected to a preferred server if it is available or to an alternate server if the preferred server is not available. The availability of the preferred server is monitored. When it is determined that the preferred server has become available, state information associated with the client session with the alternate server is used to decide when to switch the client to the now-available preferred server.

The invention may also be implemented as a computer program product for controlling client/server connections in a system in which a plurality of servers perform functions required by a client. The computer program product includes a computer usable medium embodying computer usable program code configured to receive a client request for a server connection, determine server preferences of the requesting client, connect the server to a preferred server if it is available and otherwise to an alternate server, to monitor the availability of the preferred server and, responsive to a determination that the preferred server has become available, to use state information associated with the client session with the alternate server to decide when to switch the client to the now-available preferred server.

The invention may also be implemented as a system for controlling client/server connections in a system in which a plurality of servers perform functions required by a client. A receiver component receives client server-connection requests. An accessor component determines server preferences of the requesting client and connects the requesting client to a preferred server, if available, or to an alternate server. A preference monitor monitors the availability of the preferred server. A switch component responds to a determination that a preferred server has become available by using state information associated with the client session with the alternate server to decide when to switch the client to the now-available preferred server.

### BRIEF DESCRIPTION OF THE SEVERAL VIEWS OF THE DRAWINGS

FIGS. 1-4 illustrate various scenarios in which an untimely connection switch can cause a system to operate incorrectly.

FIG. 5 is a flow chart of operations performed in a system in which the present invention is implemented.

FIG. 6 is a schematic representation of hardware components that are employed in implementing the present invention.

FIG. 7 is a flow chart of providing additional detail about specific operations performed in a system in which the present invention is implemented.

### DETAILED DESCRIPTION OF THE INVENTION

As will be appreciated by one skilled in the art, the present invention may be embodied as a method, system, or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product on a computer-usable storage medium having computer-usable program code embodied in the medium.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, RF, etc.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

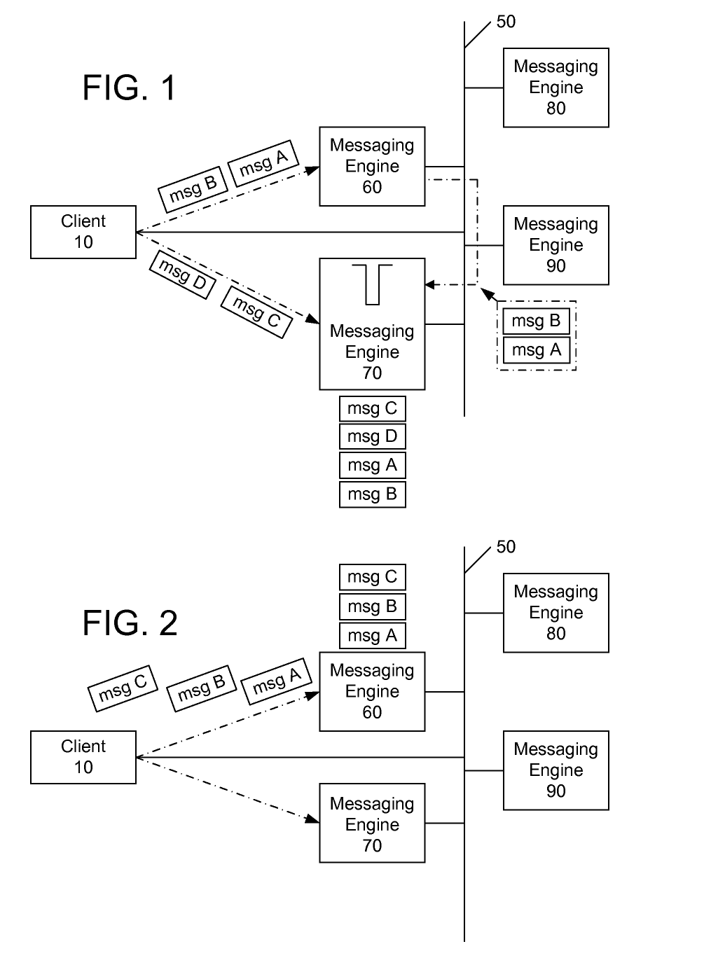

A client may connect to a server for the purpose of sending and/or receiving messages. The client may prefer to connect to a particular, preferred server even when several different servers are available to fulfil the client's request. If the preferred server is not available when a server connection is initially required, the client may be connected to an alternate server instead. When the preferred server becomes available, the client may be switched from its current server to the preferred server. In an environment involving stateful events, it is not always desirable to immediately switch a client from a current server to a preferred server that has become available since the client and server may potentially be part way through a stateful event sequence. Such a switch may result in incorrect system behavior. Some examples will be given below with respect to FIGS. 1-4.

It should be noted that the examples given are all based on ‘asynchronous messaging’ scenarios, but the invention is not limited to such an environment. In the examples provided, a messaging system is made up of multiple servers, each allowing equivalent access to clients but with certain servers having special responsibilities (e.g., owning a queue of messages) and therefore certain messaging operations must navigate to certain servers. In the example, the servers are referred to as messaging engines which communicate with each other via a bus. The invention is not however intended to be limited to such.

An asynchronous messaging provider can support the delivery of messages in a known order to a message queue located on a single messaging engine somewhere in the messaging system. The order is typically based on the order that the messages are produced by a message producing application. This ability is relied on by many messaging applications.

FIG. 1 illustrates a situation in which an untimely connection switch can cause message ordering to be lost. Client 10 begins a message producer session and produces messages in order. Client 10 prefers to send such messages to a queue 75 on messaging engine 70 but this messaging engine is unavailable at the start of the session. Client 10 is therefore connected to messaging engine 60. Client 10 produces messages A and B which reach messaging engine 60 at time T1. At time T2, messaging engine 70 becomes available and the connection with messaging engine 60 is broken in order to switch the client to messaging engine 70. Client 10 continues transmitting messages C and D which reach messaging engine 70 at time T3. Messages A and B are transmitted from messaging engine 60 in order over the bus 50 to messaging engine 70 at a later time T4. In other words, messages A and B arrive out of order at messaging engine 70 with respect to messages C and D since it takes longer to get messages from messaging engine 60 to messaging engine 70 than for messages to be delivered from client 10 directly to messaging engine 70.

FIG. 2 illustrates the situation in which an untimely connection switch can cause a transaction which is scoped to a single messaging engine to be rolled back. Client 10 starts a transaction and sends messages A, B and C to messaging engine 60 under that transaction at time T1. Client 10 is connected to messaging engine 60, which is not the client's preferred messaging engine. Messages A, B and C reach messaging engine 60 at time T2. Before the application commits the transaction to complete the sending of the messages (i.e. making the message visible at messaging engine 60), it is decided at time T3 that a connection switch should be made to a preferred messaging engine 70, which has become available. Messaging engine 60 holds the necessary state associated with this transaction and, when the switch is made to messaging engine 70, it is no longer possible to complete the transaction. Instead the transaction has to be rolled back.

FIG. 3 illustrates the situation in which an untimely connection switch may result in a client receiving the same message twice. Client 10 can communicate with messaging engines 60, 70, 80 and 90 via bus 50. Assume that client 10 creates a non-durable subscription at messaging engine 60 to receive particular messages published to bus 50. Such a non-durable subscription has a behavior defined in the Java™ Message Service (JMS) specification.

Assume publisher 85 publishes message A to messaging engine 90 at time T1. This message is propagated to the messaging engines attached to the bus 50. Message A reaches messaging engine 80 at time T2 and messaging engine 60 at time T3. Client 10 is currently connected to messaging engine 60 and had registered a subscription on messaging engine 60 and thus message A is sent along this connection at time T4 and reaches client 10 at time T5. At time T6, assume the connection with messaging engine 60 is broken because client 10's preferred messaging engine 70 has become available. Consequently, client 10 is connected to messaging engine 70 and must register the same non-durable subscription again but this time with messaging engine 70. At a later time T7, message A reaches messaging engine 70. Because client 10 has become a valid subscriber to this type of message at messaging engine 70, message A is matched to the subscriber again and is again forwarded onto client 10 at time T9. Thus, because of a delay in a message being propagated to all messaging engines attached to the bus 50 and because of the particular timing of the switchover in connections, client 10 receives message A twice.

FIG. 4 illustrates the situation in which an untimely connection switch may result in a client missing a message altogether. Assume publisher 85 publishes a message to messaging engine 90 at time T1. This message is propagated via the bus 50 to messaging engine 80 at time T2. The same message reaches messaging engine 70 at time T3. Assume messaging engine 70 does not currently have any subscribers registered to receive message A, which results in the message being deleted from messaging engine 70 at time T4. At time T5, client 10 realizes that messaging engine 70 (its preferred messaging engine) is now available and the connection with messaging engine 60 is broken. At time T6, a connection is completed between client 10 and messaging engine 70. By time T6, however, message A has already been deleted from messaging engine 70. A copy of message A does reach messaging engine 60 at time T7 (because the message is being propagated around the bus to all messaging engines) but this is too late for non-durable client subscriber 10 since it is no longer connected to messaging engine 60. Consequently client 10 fails to receive message A.

Note, non-durable subscriptions having a behavior defined in the JMS specification (and their messages) are commonly deleted when a connection is closed; that is, disconnecting from one messaging engine and re-attaching to another would lose any existing state for that subscription.

Another example of where problems can occur as a result of a switchover from one server to another is in the use of temporary queues in a request/reply environment. A client may request that a temporary queue be set up on its behalf. When the client publishes to a queue, it can specify the temporary queue as the place where any replies should be returned to the client. Temporary queues are, however, typically scoped to a particular connection. When a connection to a temporary queue is defined for a client and that connection is broken in order to make a switch to a preferred server, the temporary queue will be lost and consequently will be unable to receive replies to the original request.

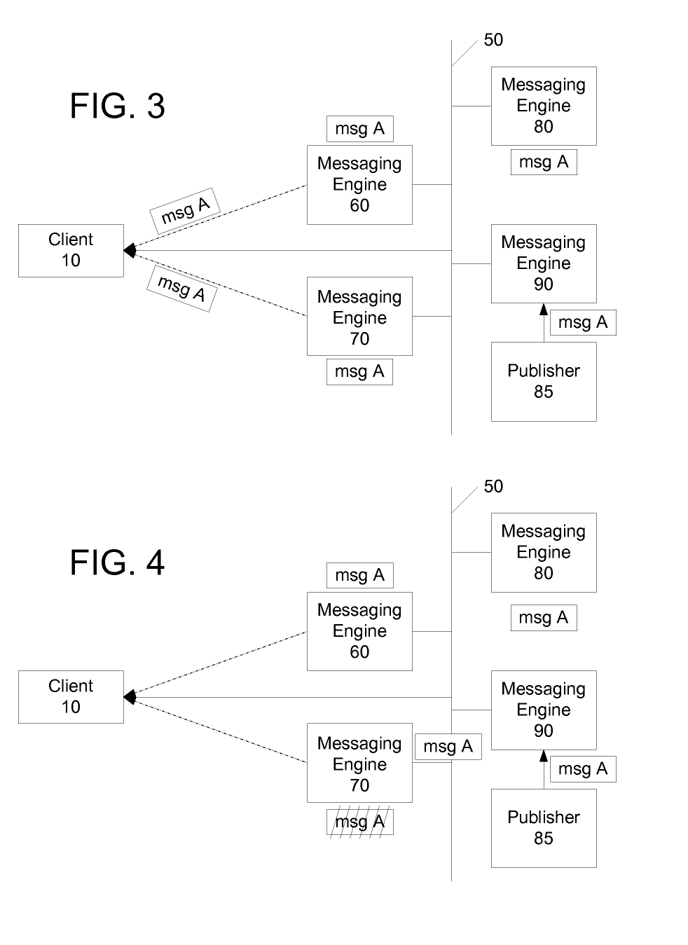

Thus it can be appreciated that switching clients from one server to another in a stateful environment can prove problematic. The solution to address this problem is described with reference to FIGS. 5-7. According to one embodiment of the present invention, a separate adapter sits between any clients and messaging engines connected to a bus. This is by way of example only and in another embodiment the logic of the adapter may, for example, be contained within each client.

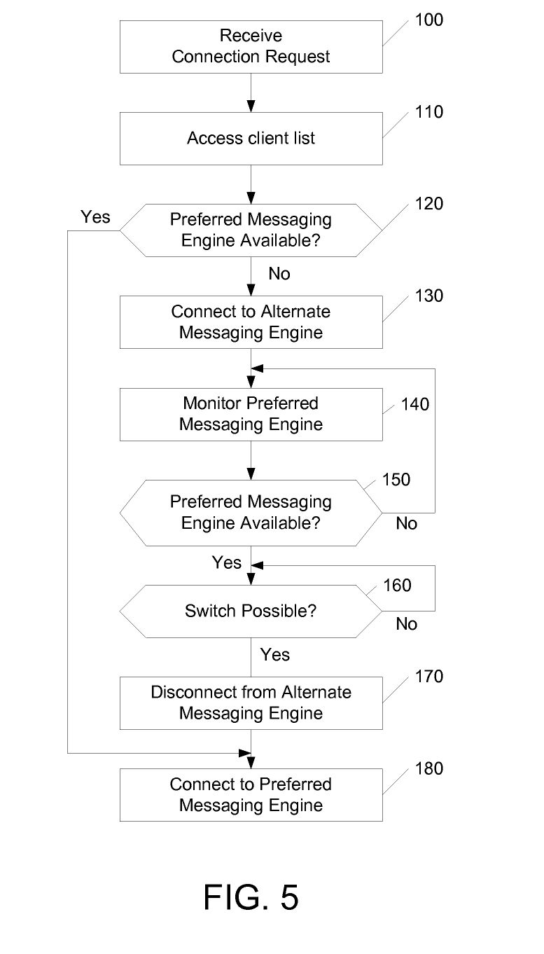

The functional components of one embodiment of an adapter are illustrated in FIG. 6. The adapter includes a receiver component 200 for receiving connection requests, a client list database for storing client preferences for connections to particular servers, an accessor 230 for retrieving the preferences of a client who wishes to establish a server connection and determining the availability of servers, a connection component for establishing client/server connections, a preference monitor for monitoring the availability of a server preferred by a connecting client and a switch component 260 for determining when the client can be safely switched from its current server to a preferred server that has become available.

Referring now to FIG. 5, a connection request is received at the receiver component of the adapter at step 100. A list 220 is defined for the client, specifying its preferred connection order in terms of the available messaging engines; that is, servers. This list is accessed at step 110. Note the list may be stored locally in the client or at the adapter itself. In a system with a plurality of clients, each client may have its own list or there may be some common storage for groups of clients. For example, one list may cover three of the clients in a twenty client system. In an alternative embodiment, endpoint target parameters may be specified which can be used to determine whether there is a client preference that should be used when connecting the client to a particular server through the bus. In other words, a client may pass one or more parameters at connect time indicating a preference, which is then dynamically evaluated.

It should be appreciated that the use of a predefined list or of dynamically-evaluated target parameters are examples only. Any mechanism which results in a preferred order of endpoints may be used.

It is determined whether the preferred messaging engine is available at step 120. If it is, then a connection is made at step 180. However if the messaging engine is unavailable then an alternate server is connected instead at step 130, thereby creating a session with the alternate messaging engine over which work can be communicated (e.g. sent and/or received). Note, this may involve traversing the client's list and considering the availability of a number of the messaging engines in turn.

At step 140, monitoring of the availability of the preferred messaging engine is begun so that it can be determined when that messaging engine is available. If it is determined at step 150 that the preferred messaging engine has become available, then a determination is made) at step 160 as to whether it is possible to make the switch to the now-available preferred messaging engine. If the answer is No, the test is repeated on a periodic basis until the switch is possible. Although this is not shown, the periodic test may include continuing to verify that the messaging engine is still available.

When it is determined that a switch is possible, the current connection to the alternate messaging engine is terminated (step 170) and a connection is established to the preferred messaging engine at step 180. In an alternative embodiment, instead of polling to determine when a switch is possible, a request may be registered for an asynchronous notification of this fact. This is also possible with respect to determining whether an messaging engine is available.

If it is determined at step 150 that the preferred messaging engine is not available, the monitoring process is continued.

An alternative flow would be to make the second connection at step 150 when the messaging engine becomes available with first terminating the current server connection. A client's workload could then be switched at a safe time. Up until this point the client would be running two connections in parallel.

Thus a determination is made at step 150 as to whether it is possible (safe) to perform a connection/workload switch since a client's preferred messaging engine is now available. A number of examples have already been given as to when it might not be safe to make a connection switch.

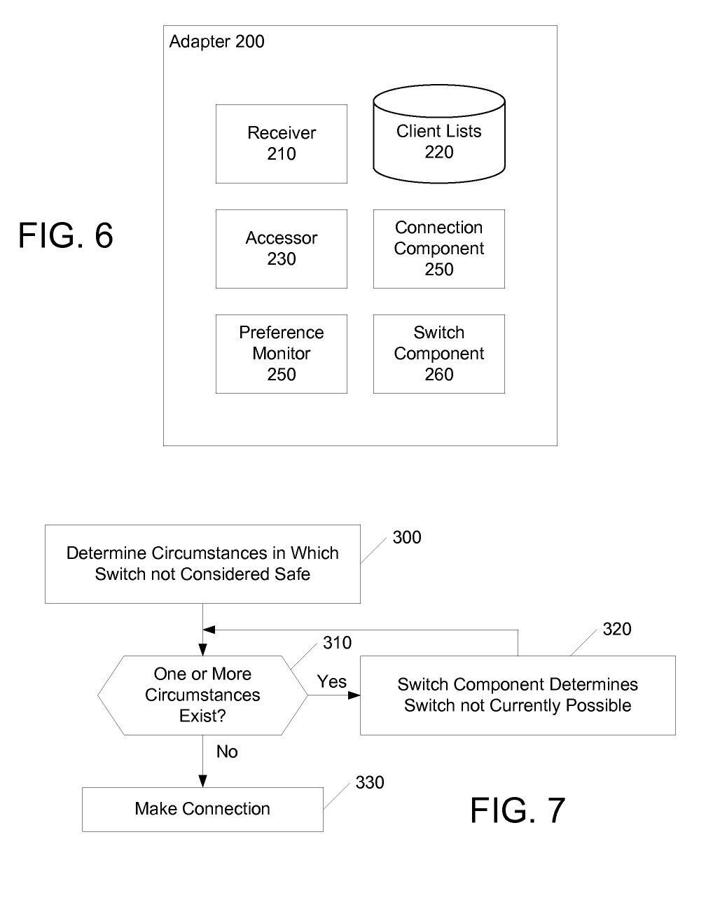

FIG. 7 expands upon the detail of step 160 which makes the determination as to whether a switch to a preferred messaging engine is possible at the current time. At step 300, the switch component determines the circumstances as to when a switch is not considered safe. This may, for example, involve accessing a set of rules which indicate such circumstances or accessing a table indicating the circumstances and whether or not they are true at the current time. Information regarding circumstances may alternatively be built into the switch component.

State information associated with the client's session with the alternate messaging engine is used at step 310 to determine whether any of the circumstances are true for the current operating environment—i.e. for the current client session with the alternate messaging engine. Such state information may be obtained at the point when it is determined that the preferred messaging engine is available.

If the answer is No, then a new connection is made and the old connection is broken (step 330). Otherwise, the switch component determines that it is unable to make the switch at the current point in time. The process then loops round and a periodic test is made to determine whether the situation has changed. An alternative solution is for the switch component to be asynchronously notified when a switch is possible.

If the situation has changed, then a connection to the preferred messaging engine is made at step 330. As previously discussed, the connection may alternately be made as soon as the preferred messaging engine becomes available, but work is not switched until such a switch is considered ‘safe’.

The testing of whether a circumstance exists in the system (i.e. step 310) will now be described in more detail.

As discussed previously, a system in which non-durable subscriptions exists is one example of an environment in which it is not possible to make a connection switch without introducing the possibility of adversely affecting the application's behavior. Consequently test 310 may involve examining the subscriptions held by adapter 200 and this may be done each time a switch is desirable. Another option however is to monitor the system continuously and when a non-durable subscriber attaches, to update a switch table accordingly. Of course the table would also need to be updated when the last non-durable subscriber goes off-line. Thus the processing in one embodiment may involve examining the table to determine the type of subscriptions present in the system. Rather than deciding that it is not safe to make a switch because non-durable subscriptions exist within the entire system, a further refinement is to store a switch table per client and to determine whether the client for which the switch is planned has any non-durable subscriptions.

Systems using temporary queues can also be problematic for the reason described previously. Again a check may be done only at the point when a switch is about to be made and this may involve determining whether any temporary queues have been defined. Alternatively the system may be monitored and when a temporary queue is first declared or the last temporary queue is deleted, a switch table can be updated accordingly. Again a refinement is to determine whether the client for which the switch is planned is using temporary queues. If a client has created a temporary queue, the client is tied to that connection until that temporary queue is deleted, that is the only indication available to it that the queue is no longer needed. It is thus typically not possible to determine when a temporary queue is actually being used.

Another example of a problematic environment is one in which transactional message flows exist. A simple solution is to declare that for a client using transactions or with the ability to have more than one message per transaction, a connection switch is not possible. This is however rather restrictive. A more advanced solution is to continuously monitor the traffic flow from and/or to the adapter 200 to determine if the adapter is part way through a transaction.

It should be appreciated that messages from one transaction may be interleaved with messages from another transaction. Clients using the same adapter and sharing a connection to the bus may send messages where those messages are multiplexed on a single connection from the adapter to the bus.

Note, it would also be possible for a client to declare up front that it will or will not be using temporary topics, non-durable subscriptions, transactional message flows of greater than one message etc. Such information could then be used in making the determination as to whether a switch is possible.

It is also preferable not to switch to the preferred messaging engine at a time when this would cause messages to become out of order (as discussed with reference to FIG. 1). This can be achieved by determining, for example, the sequence number of the message to be communicated to the preferred messaging engine and then determining whether the previously sequenced message has reached the preferred messaging engine. A switch would only be made if the previously sequenced message was already at the preferred messaging engine.

A less expensive mechanism is to rely on the definition of ‘order’ being scoped by each message producing ‘session’ (a common restriction on message order, e.g. JMS) If such a message producer session is open then the connection cannot be switched.

The existence of the use of a non-durable subscription or temporary queue can be used to ensure that duplicated or missing messages do not occur. If a non-durable subscription or temporary queue exists, then it may not be possible to switch connections (deleting one subscription and re-creating it somewhere else) without risking the loss/duplication of messages.

Note, the present invention has been described in terms of switching from an alternative server to a preferred server. A preferred server is not necessarily the client's first choice among all possible servers but simply a server that is more preferred than the server to which the client is currently connected.

While the term “messaging engine” is used herein, no limitation is intended. The term could equally be substituted for server, computer etc.

Further while the invention has been described in terms of asynchronous messaging, the invention could equally be applied to other non-messaging systems where a client has a long-running connection to a server, with preference for one server over another, and certain cross-request state or sequence requirements.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to preferred embodiments thereof, it will be apparent that modifications and variations are possible without departing from the scope of the invention defined in the appended claims.

What is claimed is:

1. A method for controlling client/server connections in a system in which a plurality of servers perform client-required functions, said method comprising:
receiving a request from a client for a server connection;
determining server preferences of the requesting client;
connecting the client to a preferred server if it is available or an alternate server if the preferred server is not available;
monitoring the availability of the preferred server; and
in response to a determination that the preferred server has become available, using state information associated with the client session with the alternate server in order to decide when to switch the client to the now-available preferred server.

2. The method of claim 1 further comprising establishing the state information in response to the determination that the preferred server has become available.

3. The method of claim 2 further comprising acquiring the state information by monitoring the client's session with the alternate server.

4. The method of claim 3 further comprising, responsive to the determination that the preferred server is available, connecting the client to the preferred server in order to create a client session with the preferred server.

5. The method of claim 4 further comprising immediately terminating the current session with the alternate server in response to the determination that the preferred server is available provided the state information indicates that immediate termination will not result in corruption of existing work.

6. The method of claim 4 further comprising:
maintaining the connection between the current server and the client even after connection to the preferred server is established; and
later terminating the connection between the current server and the client only after a determination that termination will not result in corruption of existing work.

7. A computer program product for controlling client/server connections in a system in which a plurality of servers perform client-required functions, said computer program product comprising a computer usable medium having computer usable program code, said computer usable program code comprising:
computer usable program code configured to receive a request from a client for a server connection;
computer usable program code configured to determine server preferences of the requesting client;
computer usable program code configured to connect the client to a preferred server if it is available or an alternate server if the preferred server is not available;
computer usable program code configured to monitor the availability of the preferred server; and
computer usable program code configured to in response to a determination that the preferred server has become available, use state information associated with the client session with the alternate server in order to decide when to switch the client to the now-available preferred server.

8. The computer program product of claim 7 further comprising computer usable program code configured to establish the state information in response to the determination that the preferred server has become available.

9. The computer program product of claim 8 further comprising computer usable program code configured to acquire the state information by monitoring the client's session with the alternate server.

10. The computer program product of claim 9 further comprising computer usable program code configured to, responsive to the determination that the preferred server is available, connect the client to the preferred server in order to create a client session with the preferred server.

11. The computer program product of claim 10 further comprising computer usable program code configured to immediately terminate the current session with the alternate server in response to the determination that the preferred server is available provided the state information indicates that immediate termination will not result in corruption of existing work.

12. The computer program product of claim 10 further comprising:
computer usable program code configured to maintain the connection between the current server and the client even after connection to the preferred server is established; and
computer usable program code configured to later terminate the connection between the current server and the client only after a determination that termination will not result in corruption of existing work.

13. A system for controlling client/server connections in a system in which a plurality of servers perform client-required functions, said system comprising:
a receiver component for receiving a request from a client for a server connection;
an accessor component for determining server preferences of the requesting client and for connecting the client to a preferred server if it is available or an alternate server if the preferred server is not available;
a preference monitor for monitoring the availability of the preferred server; and
a switch component for, in response to a determination that the preferred server has become available, using state information associated with the client session with the alternate server in order to decide when to switch the client to the now-available preferred server.

14. The system of claim 13 wherein the switch component further establishes the state information in response to the determination that the preferred server has become available.

15. The system of claim 14 wherein the switch component acquires the state information by monitoring the client's session with the alternate server.

16. The system of claim 15 wherein the switch component, responsive to the determination that the preferred server is available, connects the client to the preferred server in order to create a client session with the preferred server.

17. The system of claim 16 wherein the switch component immediately terminates the current session with the alternate server in response to the determination that the preferred server is available provided the state information indicates that immediate termination will not result in corruption of existing work.

18. The system of claim 16 wherein the switch component maintains the connection between the current server and the client even after connection to the preferred server is established and later terminates the connection between the current server and the client only after a determination that termination will not result in corruption of existing work.
